(19) United States
(12) Patent Application Publication
(10) Pub. No.: US 2015/0148975 A1
(43) Pub. Date: May 28, 2015

(54) SMART GRID INTEGRATED ELECTRIC POWER CONTROL SYSTEM BASED ON ESS DISTRIBUTED CONTROL

(71) Applicant: EPICO CO., LTD., Incheon (KR)

(72) Inventors: Yoo Cheol JEONG, Incheon (KR); Min Ho CHOI, Seoul (KR); Hee Joo BYUN, Incheon (KR)

(21) Appl. No.: 14/462,941

(22) Filed: Aug. 19, 2014

(30) Foreign Application Priority Data
Nov. 26, 2013 (KR) 10-2013-144773

(51) Int. Cl. G06F 1/26

(52) U.S. Cl. CPC G06F 1/26
USPC 700/287; 700/286

(57) ABSTRACT

The invention is a smart grid integrated electric power control system based on ESS distributed control, in which the households on a smart grid are grouped into plurality of local ESS areas and the electric power supplied to the households in the local ESS area is controlled distributedly by a local ESS device and the electric power supplied between the local ESS is controlled by a central ESS device integratedly.

### TECHNICAL FIELD

The present invention relates to a smart grid integrated electric power control system based on ESS distributed control, and more particularly to a smart grid integrated electric power control system based in ESS distributed control in which the households on a smart grid are grouped into a plurality of local ESS areas and the electric power supplied to the households within the local ESS area is controlled distributedly and the electric power supplied between the local ESS areas is controlled integratedly.

### BACKGROUND ART

Generally, ESS (Energy Storage System) is an electric power supply control system in which the electric power overproduced in an electric power plant is stored and the stored electric power is supplied when the electric power is in short. ESS is usually installed on an off-grid area such as an island or a remote area in which the electric power supply from the wide area electric power supply system is impossible or restricted, and it usually produces electric power by itself and supplies it to the households.

FIG. 1 shows a conventional ESS system installed on an off-grid to supply the households with electric power, and FIG. 2 is a block diagram of the conventional ESS system. AS shown, the ESS system comprises of a new renewable energy generator 11 using wind power or solar energy, a fossil fuel generator 12 using fossil fuel such as oil or coal, a battery 13 storing electric power produced in the new renewable energy generators 11, 12, a charge/discharge module 15 switching electric power to Load, and a system controller 14 controlling supply of the produced or stored electric power to the households. The system controller 14 controls in a way that firstly the electric power produced at the new renewable energy generator 11 is supplied to the households, and in case of electric power shortage produced in the new renewable energy generator 11 due to bad weather or breakdown of the generator, it controls to operate the fossil fuel generator 12 to continue the supply of the electric power to the households.

But, as the conventional ESS system is configured that one ESS system should supply electric power to all the households, the ESS system is required to produce or store the electric power to satisfy the electric power demand of all the households, which would result in high cost of construction and maintenance for the ESS system because the system should keep a large scale generator facility and battery facility. And, as one ESS system is connected to all the households one by one through each electric power supply line, if the ESS system is broken down, or the connections between the ESS system and each household is shut off, the normal supply of electric power to the households is impossible until the ESS system or the connection between the ESS system and the household is restored.

### DISCLOSURE

### Technical Problem

The present invention is contrived to solve the above-mentioned problems of the conventional art, and the object of the present invention is to provide a smart grid integrated electric power control system based on ESS distributed control in which the households on a smart grid are grouped into a plurality of local ESS areas and the supply of electric power to the households within the local ESS area is controlled by the local ESS device distributedly and the supply of electric power between the local ESS areas is controlled by the central ESS device integratedly so that costs of construction and maintenance for ES S system could be reduced, and as the local ESS areas are connected through multi-connecting networks to each other, normal supply of the electric power is possible in case of breakdown of the central ESS device or disconnection between the central ESS device and the local ESS devices.

### Technical Solution

According to an aspect of the present invention, there is provided a smart grid integrated electric power control system based on ESS distributed control in which the households on a smart grid SG are grouped into a plurality of local ESS areas Ea to Ed, and the electric power supplied to the households in the local ESS area is controlled distributedly as well as integratedly, wherein the electric power control system includes local ESS device 200 placed on each local ESS area and connected to its households and the local ESS devices 200 of the other local ESS areas through multi-connecting network R capable of communicating data and supply electric power, and having a new renewable energy generator 250 and a battery 260 and distributedly controlling to supply electric power produced in that new renewable generator 250 to the households in that local ESS area and store the surplus electric power in that battery 260; and a central ESS device 100 connected to each local ESS area through the multi-connecting network R and monitoring the state of electric power demand and supply of the local ESS areas and integratedly controlling to supply the electric power from a surplus local ESS area in which the amount of electric power production or storage is higher than the predetermined values to a deficit local ESS area in which the amount of the electric power production or storage is lower than the predetermined values.

According to another aspect of the present invention, there is provided a smart grid electric energy control system based on ESS distributed control, wherein the central ESS device 100 includes a fuel fossil generator 150, and if the central ESS device 100 detects that a deficit local ESS area exists but a surplus local ESS area does not exist, then it controls to operate the fossil fuel generator 150 to produce emergency electric power and supply it to the deficit local ESS area through the multi-connecting network R.

According to another aspect of the present invention, there is provided a smart grid integrated electric energy control system based on ESS distributed control, wherein the local ESS device 200 further includes a short circuit detector 240 detecting a short circuit in the multi-connecting network R connecting to its households, the adjacent local ESS areas and the central ESS device 100, and when the short circuit detector 240 detects a short circuit, then transmits the short circuit detecting information to the central ESS device 100, and when the central ESS device 100 receives the short circuit detecting information from the local ESS device 200, then controls to stop the operation of the corresponding local ESS device 200 and supply that local ESS area with the electric power produced or stored by other local ESS devices 200.

According to another aspect of the present invention, there is provided a smart grid integrated electric energy control system based on ESS distributed control, wherein if the central ESS device 100 is shut down or the connecting network R between the central ESS device 100 and the local ESS devices 200 is disconnected, any local ESS device 200 is given a master function according to a predetermined priority and the other local ESS devices 200 are given slave functions, and the master local ESS device 200 controls the supply of electric power for the other slave local ESS devices 200.

According to another aspect of the present invention, there is provided a smart grid integrated electric energy control system based on ESS distributed control, wherein in case that a deficit local ESS area is found and a part of the new renewable energy generators 250 of the local ESS devices 200 is to be operated, the central ESS device 100 or the master local

ESS device 200 controls to operate the new renewable energy generators 250 alternately in the predetermined sequence.

### Advantageous Effects

According to the present invention, first, by grouping the households on the smart grid into a plurality of local ESS areas and controlling the supply of electric power within each local ESS area by each local ESS device distributedly and controlling the supply of electric power between the local ESS areas by the central ESS device integratedly, a large scale generator and a large scale battery are not needed, so the cost of construction and maintenance for the system is reduced.

And, if the central ESS device 100 is shut down or the network R between the central ESS device 100 and the local ESS devices 200 is disconnected, any local ESS device 200 is given a master function and is assigned a role to control the overall system instead of the central ESS device 100, so the data communication and the normal supply of electric power is possible through the network R between each local ESS devices.

Secondly, as the central ESS device 100 includes a fossil fuel generator 150, even though there is no surplus local ESS having sufficient amount of electric power production or storage, it is possible to control to supply the deficit local ESS area being short of electrical power with the electric power produced by the fossil fuel generator 150 through the network R to achieve a stable supply of electric power.

Thirdly, as the local ESS device 200 includes a short circuit detector 240 and transmits the short circuit detecting information to the central ESS device 100, if a short circuit accident happens in a local ESS device 200, the central ESS device 100 will receive the short circuit detecting information and control to stop the operation of that local ESS device 200 to prevent the secondary accident in other local ESS devices 200 resulting from that short circuit accident, and could supply the electric power from other local ESS devices 200 to that local ESS area, so that electrical power shutoff of the questioned local ESS area could be effectively prevented.

Fourth, the local ESS device 200 and the households in any local ESS area are connected to the central ESS device 100 or other local ESS devices 200 and other households in the other local ESS areas through multi-connecting network R and are capable of communicating data and supplying electric power through the network R, so that normal data communication and normal supply of electric power is possible even though some of the network R is disconnected due to the accident or breakdown.

Fifth, if a deficit local ESS area is found and a part of the new renewable energy generator 250 of the local ESS devices 200 is to be operated, the central ESS device 100 or the local ESS device 200 with the master function could control to operate the new renewable energy generator 250 alternately in the predetermined sequence so that a life span of the new renewable energy generator 250 is extended and the maintenance cost is reduced as the generator 250 is continuously and equally operated.

Sixth, as the central ESS device 100 controlling the overall system or the local ESS device 200 given with a master function conducts the control of the electric power supply between the central ESS device 100 and the local ESS devices 200 or between each local ESS device 200, and controls the phases of electric power output from the central ESS device 100 and from each local ESS device 200 to be synchronized, the short circuit due to the phase difference is prevented.

### DESCRIPTION OF THE DRAWINGS

The above and other objects and advantages of the invention will become more apparent by describing the preferred embodiments with reference to the accompanying drawings in which:

FIG. 1 is a schematic view showing the relation between the conventional ESS system and the households

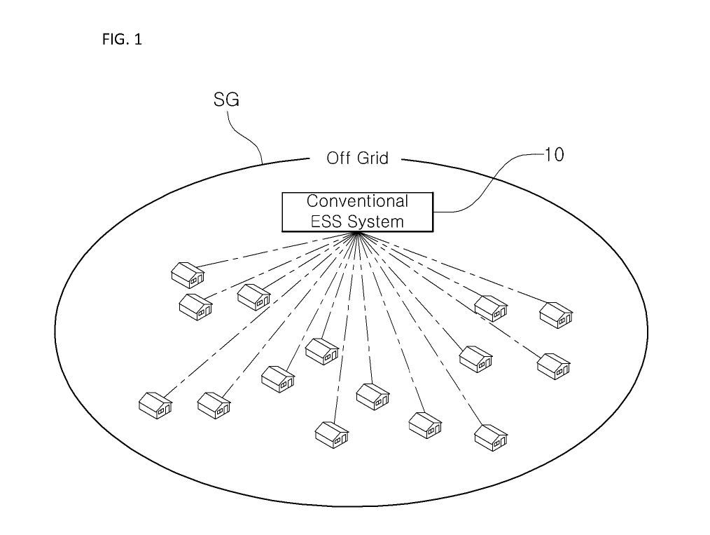

FIG. 2 is a block diagram of the conventional ESS system

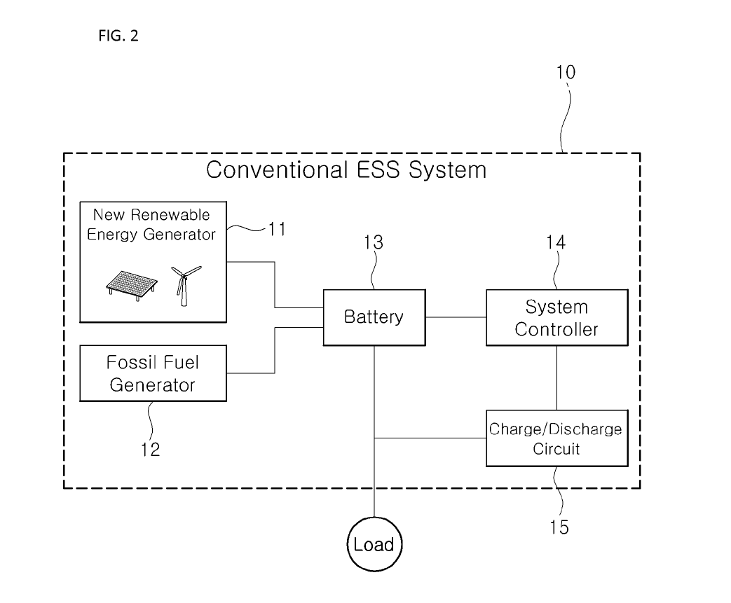

FIG. 3 is a schematic view showing a smart grid integrated electric power control system based on ESS distributed control according to the invention

FIG. 4 is a block diagram showing that the central ESS device and the local ESS devices transmits data and supplying electric power through the network R

FIG. 5 is a block diagram showing the local ESS device of the invention

FIG. 6 is a block diagram showing the central ESS device of the invention

### DETAILED DESCRIPTION OF THE INVENTION

Hereinbelow, the preferred embodiment of the invention will be described. In the following description, the term ‘smart grid’ means an intelligent electric power supply network in which the real time data communication is possible to optimize the energy efficiency. The term ‘ESS’ (Energy Storage System) means a device or system to produce electric power and supply it to the households and store the surplus electric power for future use . The term ‘fossil fuel generator’ is an electric power generator using petroleum, coal or natural gas as fuel. The term ‘new renewable energy generator’ is an electric power generator using solar energy, wind power, water, geothermal heat or bio-organic materials. The term ‘multi-connecting network’ means a network in which any two nods are connected by a plurality of connecting lines so that, even though one connecting line is disconnected, the two nods can be connected by other connecting lines.

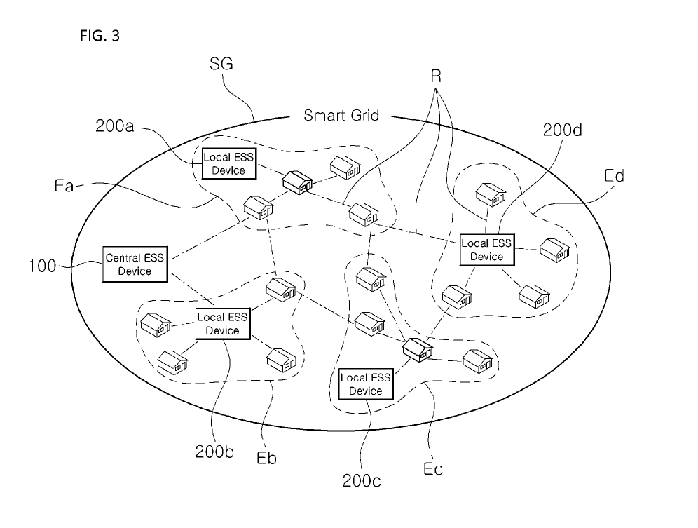

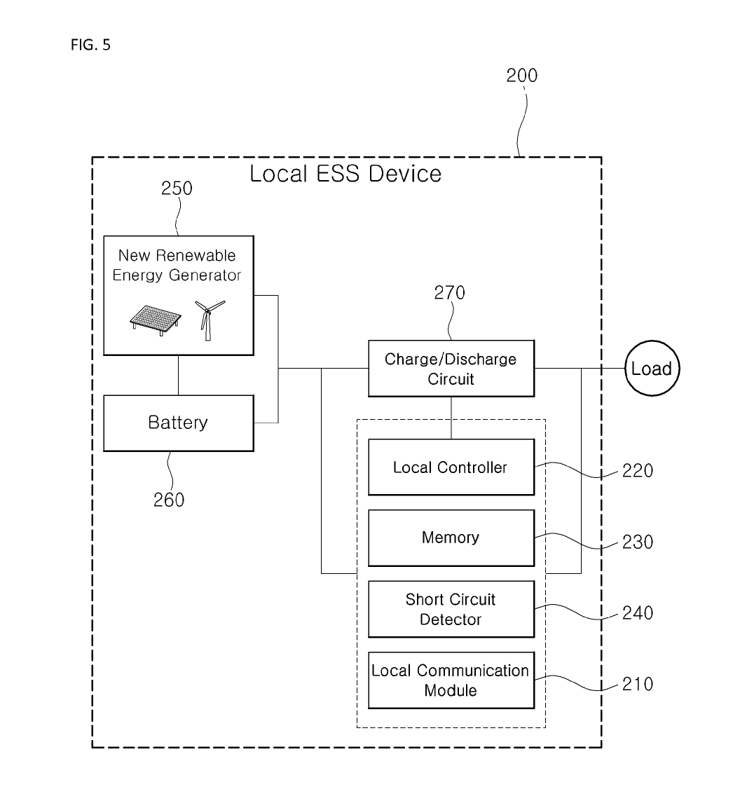

According to the invention, as shown in FIGS. 3 to 6, the households are grouped into a plurality of local ESS areas Ea-Ed, and the power supply to the houses in each local ESS area is controlled by a local ESS device 200 distributedly, and the power supply between each local ESS area is controlled by a central ESS device 100 integratedly. The local ESS device 200 is placed on each local ESS area Ea-Ed and controls the electric power supply to the households in the corresponding local ESS area. As in FIG. 5, the local ESS device 200 includes a local communicating module 210 to transmit and receive data through a network R, a new renewable energy generator 250 to produce electric power by use of renewable energy resources, a battery 260 to store electric power produced in the new renewable energy generator 250, a local controller 220 to control to produce electric power in the new renewable energy generator 250 and supply it to the households and store the produced electric power in the battery 260, a memory 230 to store data and preset items necessary to drive the local ESS device 200, and a charge/discharge circuit 270 to switch the electric power line to supply the electric power stored in the battery 260 to the loads or households according to the control signal of the local controller 220.

The local ESS area Ea-Ed is a grouping unit of the households on the smart grid SG, which is grouped so that each local ESS device 200 can supply electric power to the households within each group and the number of households in a group can be determined in consideration of the capacity of the new renewable energy generator 250 and the battery 260. For example, if the capacity of the new renewable energy generator 250 is 10 kW and an average consumption of a households is 3-4 kW, then a local ESS area Ea-Ed should include 3 to 4 households as shown in FIG. 3.

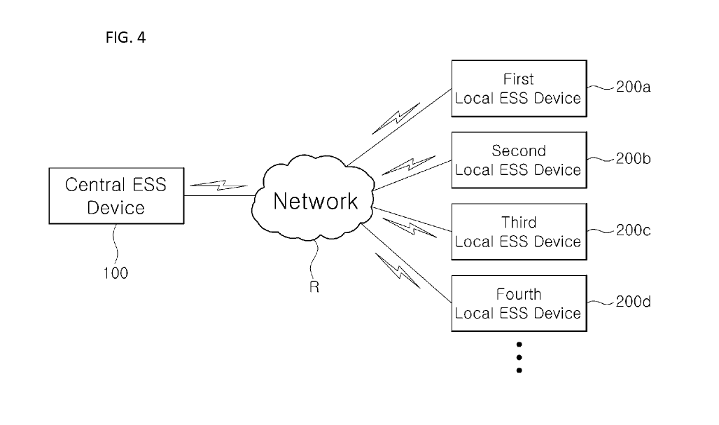

Each local ESS device 200 is connected to load (electric power inlet) of the households in the corresponding local ESS area by electric power supply line to supply the produced or stored electric power. And, as shown in FIG. 4, the local ESS devices 200 are connected to the central ESS device 100 through the multi-connecting network R which is capable of communicating data as well as supplying electric power. Accordingly the network

R has a broad mean including a data communication line and a power supply line, and the data communication line and the power supply line may be installed separately, or they may be the same line in case of Power Line Communication. Meanwhile, the data communication may be carried out through wired communication lines such as Ethernet and PLC, or it may be carried out through proper wireless communication methods.

The local ESS devices 200 of the local ESS areas Ea-Ed are connected to each other through multi-connecting network R, so that, if one connecting line between the local ESS devices 200 or between the central ESS device 100 and the local ESS device 200 is disconnected, data communication or electric power supply will be possible through other lines connecting the adjacent local ESS devices 200.

The local ESS device 200 monitors the operating state of the new renewable energy generator 250, production amount of the new renewable energy generator 250, storing amounts of the battery 260, electric power demand or consumption of the households in that local ESS area, and transmits data acquired from monitoring to the central ESS device 100 or the local ESS device 200 given a master function as mentioned below, so that the central ESS device 100 or the local ESS device with master function could monitor the state of power demand and supply of all the local ESS areas.

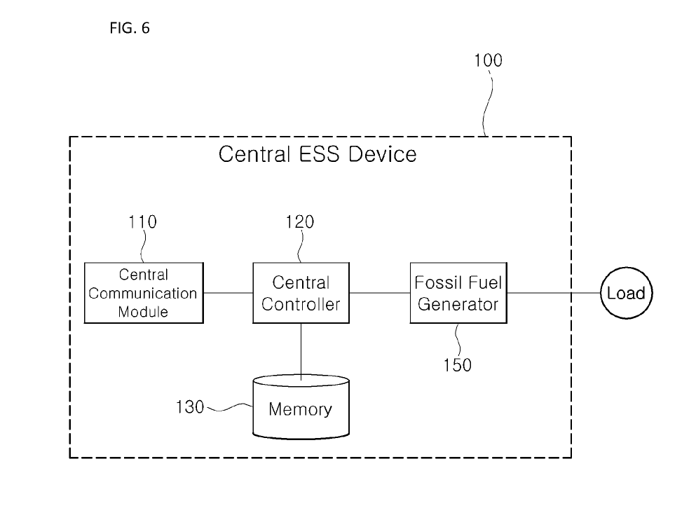

The central ESS device 100 is placed on a position of the smart grid SG and is capable of communicating data and supplying electric power to each local ESS device 200 through the multi-connecting network R so that it should control the electric power supply to all the households in the smart grid SG integratedly, and includes, as shown in FIG. 6, a central communication module 110 being capable of communicating data with the local ESS device, a fossil fuel generator 150 generating electric power using fossil fuel, a central controller 120 controlling the supply of electric power produced in the fossil fuel generator 150 and the state of demand and supply of overall local ESS areas, and a memory 130 to store data and preset items necessary to drive the central ESS device 130.

The central ESS device 100 monitors the state of demand and supply of the local ESS areas Ea-Ed and determines that any deficit local ESS area in which the amount of electric power production or storage is lower than the predetermined value exists, and if a deficit local ESS area is detected, then determines that any surplus local ESS area which is sufficient in electric power production or storage and affordable to supply the surplus electric power to other local ESS area exists. If a surplus local ESS area exists, then controls that the surplus local ESS area should supply electric power to the deficit local ESS area through the multi-connecting network R. If a surplus local ESS area does not exist, then controls to operate the fossil fuel generator 150 to produce the emergency electric power and supply it to the deficit local ESS area Ea-Ed. Here, the central ESS device 100 can output the control signal to the local ESS devices 200 through the network R and can control the operation of the new renewable energy generator 250 and the supply of electric power of the generator 250 and the battery 260 of the local ESS device 200.

As for the electric power supply between the local ESS devices 200 or from the central ESS device 100 to the local ESS device 200, if the phase of the output electric power is different to each other, the electric circuit may be shorted so the power supply may be shut down or restricted. In order to avoid this problem, the central ESS device 100 can control the phases of the electric power output from the central ESS device 100 and the local ESS device2 200 to be synchronized so that the power supply between each local ESSs device 200 or the power supply from the central ESS device to the local ESS devices 200 is possible.

The memory 130 of the central ESS device 100 stores data of the routes of multi-connecting network R between each local ESS device 200 and between the local ESS device 200 and the corresponding households so as to readout the route data connecting the deficit local ESS area to the surplus local ESS area and decides the optimized route in consideration of the shortest distance and controls to supply the electric power through the optimized route of network R. And the central ESS device 100 can operate the fossil fuel generator 150 to produce electric power and supply it to a local ESS area in which the corresponding local ESS device 200 is broken down or malfunctioned.

Meanwhile, if the central ESS device 100 is broken down or the connecting lines to the central ESS device 100 is disconnected, then the control signal from the central ESS device 100 cannot be transmitted to the local ESS device 200 so that the overall electric power control system could not be normally functioned. To avoid this problem, according to the invention, if the connection between the local ESS device 200 and the central ESS device 100 is disconnected due to the failure of the central ESS device 100, then any local ESS device 200 is given a master function according to a predetermined priority and other local ESS devices 200 are given a slave functions, and the local ESS device with the master function can control the operation of each new renewable energy generator 250 and electric power supply between the local ESS devices 200. To do this, the memory 230 of each local ESS device 200 preferably keeps the date such as preset items necessary to control the electric power supply between the local ESS devices 200. Preferably, the local ESS device 200 with the master function can transmit the control signal to synchronize the phases of the electric power of the other local ESS devices 200 with the phase of the electric power output from the corresponding local ESS device 200 before supply the electric power.

If a deficit local ESS area is found and a part of the new renewable energy generator 250 of the local ESS devices 200 is to be operated, the central ESS device 100 or the local ESS device 200 with the master function could control to operate the new renewable energy generator 250 alternately in the predetermined sequence, so that the life span of the new renewable energy generator 250 is extended and the maintenance cost is reduced as the generator 250 is continuously and equally operated.

And the central ESS device 100 can control to operate the fossil fuel generator 150 to produce electric power and supply it the deficit local ESS device 200 if the amount of electric power production of the new renewable energy generator 250 and the amount of electric power storage of the battery 260 is lower than the predetermined value. Here, the predetermined value to determine whether the electric power of each local ESS area is sufficient or deficient can be set in consideration of the estimated consumption of electric power of the households in that local ESS area.

The central ESS device 100 can receive weather information via internet or other communication network and set the levels of electric power production or storage of each local ESS device 200 to achieve efficient and optimized operation, and the received weather information would be accumulated in the memory 130 and used for establishing an estimate model of electric power production.

Preferably, in order to prevent the accident due to the short circuit, the local ESS device 200 according to the invention is provided with a short circuit detector 240 detecting the short circuit on the network R connecting to the households in the corresponding local

ESS area and the network R connecting to the adjacent local ESS areas or central ESS device 100, and when the short circuit detector 240 detects a short circuit, then the local ESS device 200 transmits the short circuit detecting information to the central ESS device 100. If the central ESS device 100 receives the short circuit detecting information from the local ESS device 200, then controls to stop the operation of the corresponding local ESS device 200 and supply it with the electric power produced or stored by other local ESS devices 200. Accordingly, if a short circuit accident is detected, the operation of the corresponding local ESS device 200 is stopped, so the secondary accident resulted from the short circuit can be prevented, and as the central ESS device 100 controls to supply electric power to that local ESS area from other local ESS device 200, the power supply interruption due to the short circuit accident can also be prevented.

According to electric power control system of the present invention as mentioned above, the electric power of the surplus local ESS areas having sufficient amount of electric power production or storage can be supplied to the deficit local ESS area lacking of electric power production and storage, or the electric power produced in the fossil fuel generator 150 of the central ESS device 100 can be supplied to the deficit local ESS area so that a stable electric power supply can be achieved in the overall smart grid SG.

And as the households in the smart grid SG are grouped into a plurality of local ESS area Ea-Ed, and the electrical power supply in the local ESS area is firstly controlled by the corresponding local ESS device 200 distributedly, and the electrical power supply between the local ESS areas is controlled by the central ESS device 100 integratedly, the system construction cost and maintenance cost can be reduced, and if the central ESS device 100 is broken down or the connecting line to the central ESS device 100 is disconnected, any local ESS device 200 can be given a master function and can control the overall system instead of the central ESS device 100, and the data communication and electric power supply are also possible between the local ESS areas through other connecting lines of the multi-connecting network R, so sustained normal electric power supply is possible.

1. A smart grid integrated electric power control system based on ESS distributed control in which the households on a smart grid (SG) are grouped into a plurality of local ESS areas (Ea to Ed), and the electric power supplied to the households in the local ESS area is controlled distributedly as well as integratedly, wherein the electric power control system includes local ESS device (200) placed on each local ESS area and connected to its households and the local ESS devices (200) of the other local ESS areas through multi-connecting network R capable of communicating data and supply electric power, and having a new renewable energy generator (250) and a battery (260) and distributedly controlling to supply electric power produced in that new renewable generator (250) to the households in that local ESS area and store the surplus electric power in that battery (260); and a central ESS device (100) connected to each local ESS area through the multi-connecting network (R) and monitoring the state of electric power demand and supply of the local ESS areas and integratedly controlling to supply the electric power from a surplus local ESS area in which the amount of electric power production or storage is higher than the predetermined values to a deficit local ESS area in which the amount of the electric power production or storage is lower than the predetermined values.

2. A smart grid electric energy control system based on ESS distributed control of claim 1, wherein the central ESS device (100) includes a fuel fossil generator (150), and if the central ESS device (100) detects that a deficit local ESS area exists but a surplus local ESS area does not exist, then it controls to operate the fossil fuel generator (150) to produce emergency electric power and supply it to the deficit local ESS area through the multi-connecting network R.

3. A smart grid electric energy control system based on ESS distributed control of claim 1, wherein the local ESS device (200) further includes a short circuit detector (240) detecting a short circuit in the multi-connecting network (R) connecting to its households, the adjacent local ESS areas and the central ESS device (100), and when the short circuit detector (240) detects a short circuit, then transmits the short circuit detecting information to the central ESS device (100), and when the central ESS device (100) receives the short circuit detecting information from the local ESS device (200), then controls to stop the operation of the corresponding local ESS device (200) and supply that local ESS area with the electric power produced or stored by other local ESS devices (200).

4. A smart grid integrated electric energy control system based on ESS distributed control of 1, wherein if the central ESS device (100) is shut down or the connecting network R between the central ESS device (100) and the local ESS devices (200) is disconnected, any local ESS device (200) is given a master function according to a predetermined priority and the other local ESS devices (200) are given slave functions, and the master local ESS device (200) controls the supply of electric power for the other slave local ESS devices (200).

5. A smart grid integrated electric energy control system based on ESS distributed control of claim 4, wherein in case that a deficit local ESS area is found and a part of the new renewable energy generators (250) of the local ESS devices (200) is to be operated, the central ESS device (100) or the master local ESS device (200) controls to operate the new renewable energy generators (250) alternately in the predetermined sequence.

6. A smart grid integrated electric energy control system based on ESS distributed control of claim 2, wherein if the central ESS device (100) is shut down or the connecting network R between the central ESS device (100) and the local ESS devices (200) is disconnected, any local ESS device (200) is given a master function according to a predetermined priority and the other local ESS devices (200) are given slave functions, and the master local ESS device (200) controls the supply of electric power for the other slave local ESS devices (200).

7. A smart grid integrated electric energy control system based on ESS distributed control of claim 3, wherein if the central ESS device (100) is shut down or the connecting network R between the central ESS device (100) and the local ESS devices (200) is disconnected, any local ESS device (200) is given a master function according to a predetermined priority and the other local ESS devices (200) are given slave functions, and the master local ESS device (200) controls the supply of electric power for the other slave local ESS devices (200).
